(19) United States
(12) Patent Application Publication
(10) Pub. No.: US 2010/0284885 A1
(43) Pub. Date: Nov. 11, 2010

(54) Recovery Of Silicon And Silicon Carbide Powder From Kerf Loss Slurry Using Particle Phase-Transfer Method

(75) Inventors: Yi-Der Tai, Taipei (TW); Yen-Chih Lin, Tainan (TW)

Correspondence Address: BEVER HOFFMAN & HARMS, LLP;901 Campisi Way, Suite 370, Campbell, CA, 95008, US

(73) Assignee: National Taiwan University, Taipei (TW)

(21) Appl. No.: 12/637,676

(22) Filed: Dec. 14, 2009

(30) Foreign Application Priority Data
May 11, 2009 (TW) 098115605

(51) Int. Cl. C01B 31/36; C01B 33/02

(52) U.S. Cl. 423/345; 423/348; 423/349

(57) ABSTRACT

Silicon and silicon carbide (SiC) are recovered from kerf loss slurries using two-staged particle phase-transfer method. In the first stage, first sample, which is prepared from kerf loss slurries with silicon content being higher than SiC content, is mixed with water and oil to form first mixture, which is settled to form a water and an oil phase. The first product obtained by centrifugation from water phase has a high Si content. In the second stage, the first product is mixed with water and another oil to form the second mixture which is separated thereby to obtain the second product from water phase. The second product is the preferred silicon powder. Besides, another product, i.e. recovered SiC, is obtained by centrifugation from oil phase of the first stage. Furthermore, if silicon content is lower than SiC content, the first stage is repeated using the first product.

### FIELD OF THE INVENTION

The present invention relates to a method for recovering silicon (Si) and silicon carbide (SiC) from the kerf loss slurry. In particular, the present invention relates to a method for recovering silicon and SiC from the kerf loss slurry using particle phase-transfer method.

### BACKGROUND OF THE INVENTION

Solar energy has been incrementally developed as an important source of energy for human beings; however, the fabrication of solar cell faces the problem that the supply of silicon material is insufficient to result in high manufacturing cost. Therefore, development of economic silicon material or recycling/recovering of silicon material plays an important role in the photovoltaic (PV) industry.

Generally speaking, up to 30%˜40% of crystalline silicon material is lost easily in the wire-saw process, in which a large quantity of abrasive slurry for slicing silicon ingot are used. The components of waste slurry mainly include water, SiC abrasive, Si kerf, lubricant and metal fragments, which are produced by the attrition between stainless-steel wire and abrasive particles. Water solution functions to dilute the abrasive particles and takes away energy generated in wire-saw process. The cutting action is achieved by the attrition between Si crystal surface and SiC particles, which are carried by the slurry into the sawing channels. Silicon carbide is adopted to be the abrasive grains because its rigidity and low price. Silicon carbide accounts for high percentage in the waste slurry because of its abundant usage. Therefore, it takes efforts in recovering SiC from the waste slurry in the prior art. In addition, because a part of SiC particles are relatively small (about 1 μm or less). The small SiC particles are not easily separated from silicon. Further, the development of silicon recovering process is also relatively difficult because the demand on purity of silicon material is relatively high in the PV industry.

U.S. Pat. No. 6,780,665 discloses a recovering technology of silicon from the waste slurry, in which the surfactant is added to modify the surface property of silicon, then silicon is separated by froth flotation. Although U.S. Pat. No. 6,780,665 provides the feasibility of froth flotation, no experimental results is presented. Wang et al. (2008) disclosed a separation method for silicon and SiC, wherein the procedures include centrifugation, high-temperature treatment and directional solidification. The centrifugation method is performed by introducing a liquid having a density between that of Si and SiC. The obtained silicon from centrifugation then is processed with a high-temperature treatment and a directional solidification so as to manufacture silicon as a solar-grade silicon ingot. However, the effect of centrifugation for separating silicon is limited. No matter how the operating variables are adjusted, such as specific gravity of liquid, centrifugation time and solid concentration, the purity of silicon cannot be efficiently improved. Thus, the highest purity of silicon by centrifugation is merely 91 weight percentage (wt %) with a recovery of 73%. Further, the overall recovery of silicon is merely about 45% after the subsequent high-temperature treatment and directional solidification. In the meanwhile, Wang et al. (2008) also found that in the high-temperature treatment and directional solidification, the higher purity of silicon powder leads to a higher recovery of the solar-grade silicon. Accordingly, the particle phase-transfer method endeavored by the inventors of the present invention is substituted for centrifugation so that purity and recovery of the recovered silicon are improved and simultaneously the recovery of SiC powder is achieved.

It is therefore attempted by the applicant to deal with the above situation encountered in the prior art.

### SUMMARY OF THE INVENTION

High purity and high recovery of silicon and/or SiC powder are recovered from the slurry using the two-staged particle phase-transfer method by taking advantage of the difference in surface properties (hydrophilicity/hydrophobicity), and specific gravity between the silicon and SiC particles. Furthermore, silicon with different weight percentage in slurry is recovered by controlling the experimental parameters including, pH value of water phase, solid concentration and oil/water volume ratio, etc. The recovered high-purity silicon can be used as the silicon material for manufacturing solar-grade silicon ingot, whereas the recovered SiC powder can be recycled as the abrasive slurry de novo so that the cost for the PV industry is reduced. The particle phase-transfer method also can be applied in stages more than two, and silicon with high purity can be recovered from slurry of a lower silicon content.

In the course of experiment of the present invention, it is found that silicon particles are seriously aggregated when the acid-washed silicon particles are suspended in the tribromomethane (CHBr₃). Since the silicon surface is covered by a hydrophilic silicon dioxide (SiO₂) layer due to oxidation in acid washing, the silicon particles are aggregated in the CHBr₃. In addition, since the SiC is more stable and un-oxidized and its surface is hydrophobic, the separation of silicon and SiC is performed by the difference in the surface property, i.e., hydrophilicity versus hydrophobicity in the present invention.

In accordance with a first aspect of the present invention, a method for obtaining at least one of a silicon and a silicon carbide is provided. The method includes steps of: (a) providing a first sample; (b) sequentially mixing the first sample with a first water and a first oil to form a first mixture; (c) settling the first mixture to form a first water phase having a first water phase specific gravity and a first oil phase having a first oil phase specific gravity, wherein the specific gravity of first water phase is lower than that of first oil phase; and (d) centrifuging and drying the first water phase to obtain a first product of high silicon content and drying the first oil phase to obtain the silicon carbide-rich product.

Preferably, the first sample is a kerf loss slurry including the silicon, the silicon carbide, an ethylene glycol and a metal fragment, and the step (a) further includes steps of: (a1) washing the slurry with an acetone to remove the ethylene glycol therefrom; (a2) mixing the slurry with a nitric acid to dissolve the metal fragment therefrom and to obtain a preliminarily purified slurry; and (a3) centrifuging and drying the preliminarily purified slurry to obtain a powder mixture, which includes the silicon and the silicon carbide, being the first sample.

Preferably, the first oil includes an alcohol having a carbon number≧4 and a tribromomethane or includes an alkane having a carbon number≧4 and the tribromomethane, and the step (b) further includes a step (b1) of adding a surfactant into the first sample after the first sample and the first water are mixed.

Preferably, the surfactant is a sodium hexametaphosphate, and the step (b1) further includes a step (b11) of adjusting a pH value of the first sample with an acid or a base.

Preferably, the pH value is ranged between 3.0 and 10.3, the acid is a hydrochloride, and the base is a sodium hydroxide.

Preferably, the first mixture has a first ratio of the first oil to the first water ranged between 1/10 and 1/3, and the first mixture has a solid concentration ranged between 2 wt % and 16 wt %.

Preferably, the silicon in the first product has a first weight percentage and the silicon carbide in the first product has a second weight percentage.

Preferably, the first weight percentage of Si is equal to or greater than the second percentage of SiC, and the method further includes steps of: (e) sequentially mixing the first product with a second water and a second oil to form a second mixture; (f) settling the second mixture to form a second water phase having a second water phase specific gravity and a second oil phase having a second oil phase specific gravity, wherein the specific gravity of second water phase is higher than that of second oil phase; and (g) centrifuging and drying the second water phase to obtain a second product of high-purity silicon.

Preferably, the second oil is a solvent being one selected from a group consisting of an aromatic, an alkane, an alcohol, an ether and a diesel.

Preferably, the aromatic is a xylene, the alkane has a carbon number≧4 and includes an n-heptane and an isooctane, the alcohol has a carbon number C≧4 and includes an n-butanol, an n-pentanol, an n-hexane and an n-octanol, and the ether is an isopropyl ether.

Preferably, the second mixture has a second ratio of the second oil over the second water ranged between 1/10 and 1/3, and the second mixture has a solid concentration ranged between 2 wt % and 12 wt %.

Preferably, the step (e) further includes a step (e1) of adding a surfactant into the first product after the first product and the second water are mixed.

Preferably, the step (e1) further includes a step (e11) of adjusting a pH value of the first product with one of an acid or a base, the pH value is ranged between 1.0 and 10.0, the acid is a hydrochloride, and the base is a sodium hydroxide.

In order to achieve high-efficiency separation, it also takes account of gravity in the present invention. Since SiC has a high density and a part of SiC has relatively large particle size, SiC would be settled in the slurry in the separation process. Therefore, the density/specific gravity of the first oil phase must be higher than that of the first water phase. If the density/specific gravity of the first oil phase is lower than that of the first water phase, SiC particles would be settled in the water phase after the first mixture settlement so that silicon and SiC cannot be separated with each other. The first oil phase prepared from n-butanol and CHBr₃ can effectively make large SiC particles enter in the first oil phase.

Preferably, the first percentage is lower than the second percentage, and the method further includes steps of: (e) sequentially mixing the first product with a third water and a third oil to form a third mixture; (f) settling the third mixture to form a third water phase having a third water phase specific gravity and a third oil phase having a third oil phase specific gravity, wherein the specific gravity of third water phase is lower than that of the third oil phase; and (g) centrifuging and drying the third water phase to obtain a third product of high silicon content and the third oil phase to obtain the silicon carbide-rich product.

Preferably, the method further includes steps of: (h) sequentially mixing the third product with a fourth water and a fourth oil to form a fourth mixture; (i) settling the fourth mixture to form a fourth water phase having a fourth water phase specific gravity and a fourth oil phase having a fourth oil phase specific gravity, wherein the fourth water phase specific gravity is higher than the fourth oil phase specific gravity; and (j) centrifuging and drying the fourth water phase to obtain a fourth product of high-purity silicon.

In accordance with a second aspect of the present invention, a method for obtaining at least one of a silicon and a silicon carbide is provided. The method includes steps of: (a) providing a first sample; (b) mixing the first sample, a first water and a first oil to obtain a first mixture; (c) settling the first mixture to form a water layer having a first density and an oil layer having a second density, wherein the first density is lower than the second density; and (d) centrifuging and drying the water layer to obtain a product of high silicon content and the oil layer to obtain the silicon carbide-rich product.

Preferably, the step (b) is performed by sequentially mixing the first sample with the first water and the first oil.

In accordance with a third aspect of the present invention, a method for recovering at least one of a silicon and a silicon carbide from a slurry is provided. The method includes steps of: (a) administrating the slurry as a first sample; (b) mixing the first sample with a hydrophilic solvent and a hydrophobic solvent to obtain a first mixture; (c) settling the first mixture to form a layer of hydrophilic solvent having a first specific gravity and a layer of hydrophobic solvent having a second specific gravity, wherein the first specific gravity is lower than the second specific gravity; and (d) centrifuging and drying the layer of hydrophilic solvent to obtain a product of high silicon content and the layer of hydrophobic solvent to obtain the silicon carbide-rich product.

Preferably, the step (b) is performed by sequentially mixing the first sample with the hydrophilic solvent and the hydrophobic solvent.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 illustrates a flowchart in accordance with a first preferred embodiment of the present invention;

FIG. 2 illustrates a diagram showing the particle size distribution of dried slurry and silicon carbide in accordance with the first preferred embodiment of the present invention;

FIG. 3 illustrates a diagram showing the effect of the pH value of the first water phase on purity and recovery of silicon in the first-staged particle phase-transfer method in accordance with the first preferred embodiment of the present invention;

FIG. 4 illustrates a diagram showing the effect of the solid concentration on purity and recovery of silicon in the first-staged particle phase-transfer method in accordance with the first preferred embodiment of the present invention;

FIG. 5 illustrates a diagram showing the effect of oil/water volume ratio on purity and recovery of silicon in the first-staged particle phase-transfer method in accordance with the first preferred embodiment of the present invention;

FIG. 6 illustrates a diagram showing the effect of the carbon number of alcohol in the oil phase on purity and recovery of silicon in the second-staged particle phase-transfer method in accordance with the first preferred embodiment of the present invention;

FIG. 7 illustrates a diagram showing the effect of the pH value of the second water phase on purity and recovery of silicon in the second-staged particle phase-transfer method in accordance with the first preferred embodiment of the present invention;

FIG. 8 illustrates a diagram showing the effect of the solid concentration on purity and recovery of silicon in the second-staged particle phase-transfer method in accordance with the first preferred embodiment of the present invention;

FIG. 9 illustrates a diagram showing the effect of oil/water volume ratio on purity and recovery of silicon in the second-staged particle phase-transfer method in accordance with the first preferred embodiment of the present invention; and

FIG. 10 illustrates a flowchart in accordance with a third preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

### Embodiment 1

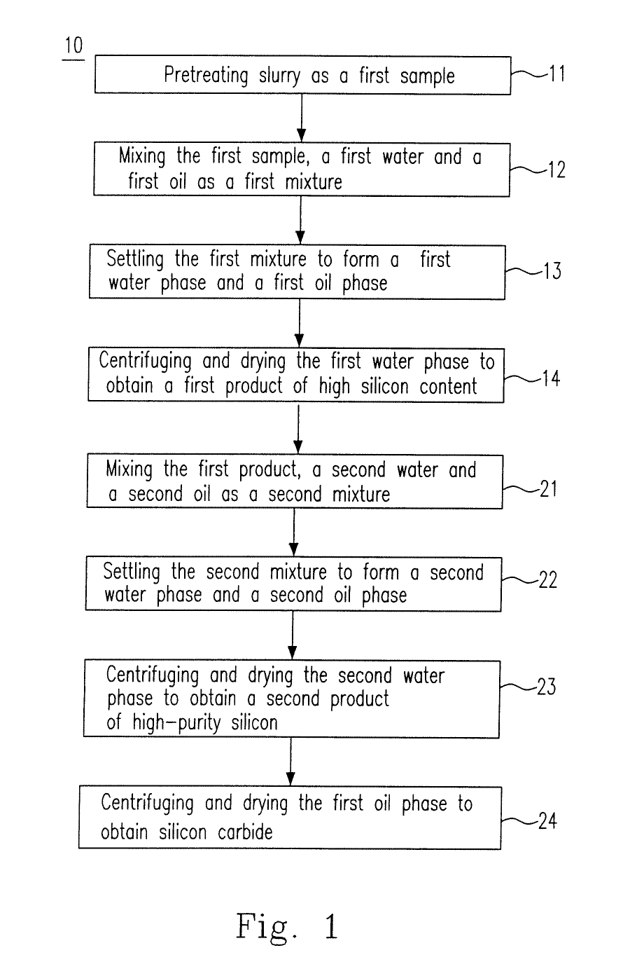

Please refer to FIG. 1, which illustrates a flowchart in accordance with a first preferred embodiment of the present invention. In the method 10 of FIG. 1, slurry is treated to obtain a first sample (step 11). The particle phase-transfer method of the present invention is divided as two stages. In the first stage, the first sample is sequentially mixed with a first water and the first oil to form a first mixture (step 12). The first mixture is settled to separate into a first water phase and a first oil phase using the hydrophilicity/hydrophobicity difference between silicon and SiC particles and specific gravity of the first oil phase higher than that of the first water phase in the first mixture (step 13). The first water phase is centrifuged and dried to obtain a first product, and purity and recovery of silicon in the first product is determined (step 14). In the second stage, the first product is sequentially mixed with a second water and a second oil to form a second mixture (step 21). Similarly, the second mixture is settled to separate into a second water phase and a second oil phase using the hydrophilicity/hydrophobicity difference between silicon and SiC powder and specific gravity of the second oil phase lower than that of the second water phase in the second mixture (step 22). The second water phase is centrifuged and dried to obtain a second product, and purity and recovery of silicon in the second product is determined (step 23). In addition, the first oil phase is centrifuged and dried to obtain SiC powder, and purity and recovery of SiC are determined (step 24). In accordance with the above-mentioned method 10, the silicon material from the kerf loss slurry can be effectively recovered and reused. The detailed experiments and discussions are illustrated as follows.

The raw material of embodiment 1 is originated from the kerf loss slurry. The slurry mainly contains silicon, SiC powder, ethylene glycol solution and metal fragments. First of all, 20 g slurry is washed with acetone and centrifuged to withdraw ethylene glycol solution and oil of the slurry, and weight M1 of intermediate 1 is recorded after drying. Subsequently, intermediate 1 is washed with nitric acid to dissolve the metal fragments, and weight M2 of intermediate 2 is recorded after drying. Silicon in the intermediate 2 is dissolved in the mixture of hydrogen fluoride (HF)/hydrogen peroxide (H₂O₂), then the SiC residue is dried, and weight M3 of SiC powder is recorded. The composition of the slurry is determined by formulas I to IV.

$$\begin{matrix}Weight percentage of ethylene glycol = \frac{20 g - M 1}{20 g} \times 100 \% & formula I \\ Weight percentage of metal fragments = \frac{M 1 - M 2}{20 g} \times 100 \% & formula II \\ Weight percentage of silicon = \frac{M 2 - M 3}{20 g} \times 100 \% & formula III \\ Weight percentage of SiC powder = \frac{M 3}{20 g} \times 100 \% & formula IV\end{matrix}$$

It is known that silicon, ethylene glycol, SiC powder and metal fragments respectively account for 44.5%, 26.1%, 16.4% and 12.9% in 20 g slurry.

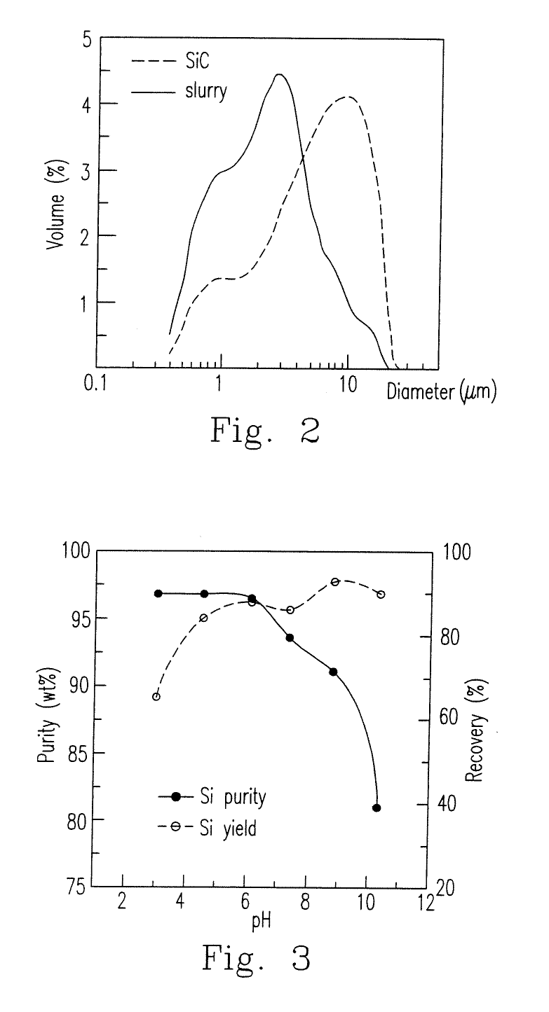

Next, a small sample of the slurry or SiC powder is dispersed and agitated in the ethylene glycol solution (the carrier), and particle size distributions of slurry and SiC powder are determined by the static light scattering analyzer (LS230, Coulter). Please refer to FIG. 2, which illustrates a diagram showing the particle size distribution of slurry and silicon carbide in accordance with the first preferred embodiment of the present invention. In FIG. 2, the dash line shows the particle size distribution of SiC powder, and solid line represents that of slurry. Silicon carbide curve shows two peaks, 1 μm and 9 μm respectively, whereas the slurry curve also represents two peaks, 1 μm and 2.5 μm respectively. Apparently, most of SiC particles are larger than the Si particles, and some of the SiC particles are below 1 μm. Because submicron particles cannot be easily settled, the removal of small SiC powder is one of the problems to be overcome in the present invention.

Subsequently, the slurry which mainly contains silicon and SiC is subject to a separation operation. Since hydrophilic silicon dioxide (SiO₂) layer is formed on silicon particle surface after the nitric acid treatment, and the SiC particles still maintain hydrophobic due to the relatively stable chemical property of SiC. The difference of surface hydrophilicity/hydrophobicity of particles is used to separate two kinds of particles in the separation process and as the theory of particle phase-transfer method of the present invention. In the first-staged particle phase-transfer method, in addition to the difference of surface characteristics of particles, the gravity effect is also employed. Because of the higher specific gravity and the large particle size of a part of SiC powder, which settles during separation, the n-butanol-tribromomethane (CHBr₃) mixture is adopted to be the first oil. Although the first oil is composed of n-butanol and CHBr₃, n-butanol can be substituted by alcohol having a carbon number≧4, such as n-pentanol, n-hexanol and n-octanol, etc. Furthermore, the first oil also can be composed of alkane having a carbon number≧4 (such as n-heptane and isooctane) and CHBr₃.

The powder containing 73.1 wt % silicon is mixed with a solution of a surfactant (e.g. sodium hexametaphosphate) concentration of 0.2 g/L to form a 2 wt % slurry, and then pH value is adjusted with hydrochloride (HCl) or sodium hydroxide (NaOH). Next, the first oil having a density of 1.1 g/cm³ prepared from mixing n-butanol and 96 wt % CHBr₃ is added therein to form a first mixture and oil/water ratio of 1/3. After approximately 5-minute mixing and 10-minute settlement, a large part of SiC paricles enters into the first oil phase, whereas most of the silicon particles remain in the first water phase (pH 7.3). Particles in the first water phase are centrifuged, washed and dried to obtain the first product. Weight and carbon content of the first product are analyzed. The purity of Si-rich powder was determined by the Carbon/Sulfur analyzer (Leco, CS-244), and the recovery was calculated by the formula V, i.e., the weight of Si in product divided by the weight of Si in the starting material, and then multiplied by one hundred percent.

The recovery of Si is defined as:

$$Recovery = \frac{weight of Si in product}{weight of Si in starting material} \times 100 \% \qquad formula V$$

Experiment 1: Effect of pH Value of the First Water Phase in the First Stage

Since particles are suspended in the water in the first-staged separation, the zeta potential of particles varied with different pH values would influence the dispersion of particles and thus the separation efficiency. Therefore, the pH value of the first water phase is set between 3 and 10.3, and the effect of the pH value of the first water phase on purity and recovery of silicon in the first product is discussed. Please refer to FIG. 3, which illustrates a diagram showing the effect of the pH value of the first water phase on purity and recovery of silicon in the first-staged particle phase-transfer method. In FIG. 3, the experimental parameters are controlled at solid concentration of 2 wt % and oil/water volume ratio of 1/3. Purity of silicon increases from 80.3 wt % to 96.6 wt % with pH value of water phase decreased from 10.3 to 6; however, purity of silicon does not change significantly when pH value thereof decreases from 6 to 3. In addition, recovery of silicon decrease from 89.9% to 65.3% when pH value thereof decreases from 10.3 to 3.

Experiment 2: Effect of the Solid Concentration in the First Stage

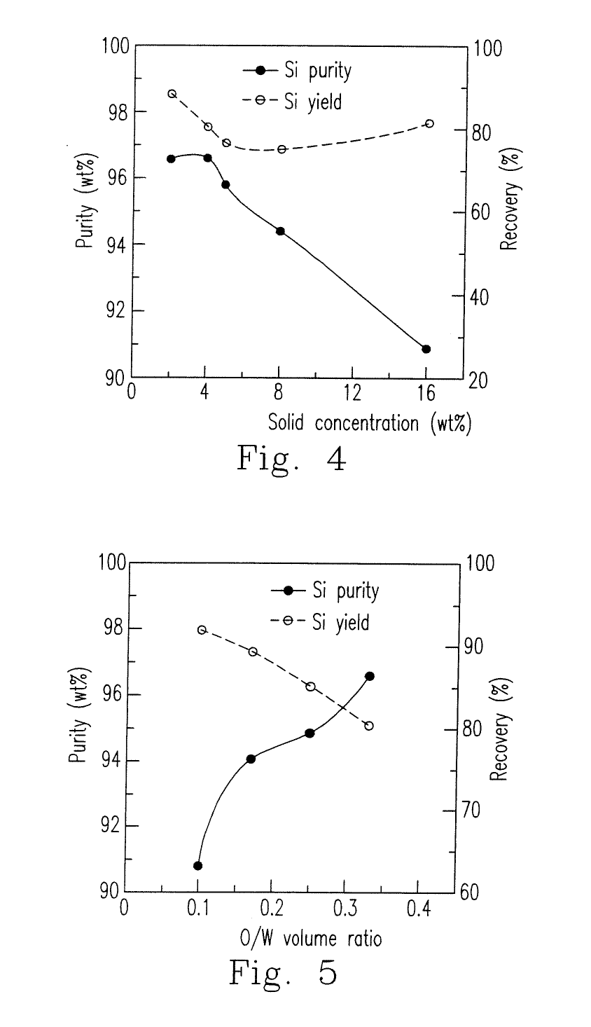

Although a high-purity of silicon can be obtained from the first mixture of 2 wt % particle content in the first stage, the production of silicon might not be sufficient for PV industry usage. Therefore, solid concentration is varied to increase production of silicon. Please refer to FIG. 4, which illustrates a diagram showing the effect of the solid concentration on purity and recovery of silicon in the first-staged particle phase-transfer method. In FIG. 4, the experimental parameters are controlled at the pH value of the first water phase of 6.1 and oil/water volume ratio of 1/3. Purity of silicon still maintains at 96.6% when the solid concentration increases from 2 wt % to 4 wt %; however, purity of silicon decreases from 96.6 wt % to 90.9 wt % when the solid concentration increases from 4 wt % to 16 wt %. In addition, recovery of silicon decreases from 88.2% to 74.9% when the solid concentration increases from 2 wt % to 8 wt %, whereas recovery of silicon increases to 81.4% when solid concentration increases to 16 wt %.

Experiment 3: Effect of Oil/Water Volume Ratio in the First Stage

In addition to solid concentration being the important parameter, oil/water volume ratio also is another important parameter in designing a practical separation process. Oil/water volume ratio of 1/3 represents that the first oil phase and the first water phase have volume of 33 ml and 100 ml, respectively, in the first-staged particle phase-transfer method. Oil/water volume ratio ranged between 1/10 to 1/3 is controlled by adjusting volume of the first oil phase. Please refer to FIG. 5, which illustrates a diagram showing the effect of oil/water volume ratio on purity and recovery of silicon in the first-staged particle phase-transfer method. In FIG. 5, the experimental parameters are controlled at solid concentration of 4 wt % and pH value of water phase of 6.1. Purity of silicon decreases from 96.6 wt % to 90.8 wt % with recovery of silicon incrementally increased from 80.3% to 91.9% when oil/water volume ratio decreases from 1/3 to 1/10.

Since a part of SiC powder smaller than 1 μm still remains in the recovered silicon after the first-staged particle phase-transfer method, smaller particle size SiC is further withdrawn by the second stage of particle phase-transfer method. The separated silicon (purity of 96.6 wt % and recovery of 88.3%) obtained by controlling the parameters (i.e. pH value of the first water phase of 6.1, solid concentration of 2 wt %, oil/water volume ratio of 1/3 and density of the first oil of 1.1 g/cm³) in the first stage is used as the starting material in the second stage. This first product is dispersed in the second water, and the surfactant (such as sodium hexametaphosphate) is added therein to resuspend particles, and then the pH value is adjusted with HCl or NaOH. Subsequently, the intermediate is adequately mixed with the second oil (n-butanol or other pure solvent) for 5 minutes to form the second mixture. The second water phase is centrifuged and dried in accordance with the illustration in step 16 of FIG. 1 after settling for 10-minute, and purity of silicon from the obtained second product is 98.6 wt % with recovery of silicon of 79.8%.

Experiment 4: Effect of the Types of the Second Oil in the Second Stage

Since smaller particle size SiC powder is transferred from the water phase to the oil phase depending on affinity between the particle surface and the oil phase, xylene, n-heptane, isooctane, diesel, n-butanol and isopropyl ether are selected to be the candidates of the second oil in the experiment. Please refer to Table 1, which illustrates the effect of different types of oils on silicon separation in the second-staged particle phase-transfer method. In Table 1, the experimental parameters are controlled at the initiated purity of silicon of 96.6 wt %, solid concentration of 2 wt %, oil/water volume ratio of 1/3 and pH value of water phase of 7.3. All the second oils show the effect for silicon separation, wherein n-butanol is the most significant one. Purity of the recovered silicon is 98.6 wt % with recovery of silicon of 79.8%.

TABLE 1
Effect of different types of the second oils on silicon separation
in the second-staged particle phase-transfer method

| | | Purity (wt %) | Recovery (%) |
|---|---|---|---|
| | | of separated | of separated |
| No. | Second Oil | silicon | silicon |
| 1 | Xylene | 97.5 | 55.5 |
| 2 | n-Heptane | 97.9 | 75.8 |
| 3 | Isooctance | 97.5 | 77.0 |
| 4 | Diesel | 97.7 | 47.3 |
| 5 | n-Butanol | 98.6 | 79.8 |
| 6 | Isopropyl ether | 97.9 | 45.0 |

Experiment 5: Effect of Alcohol with Long Carbon Chain in the Second Stage

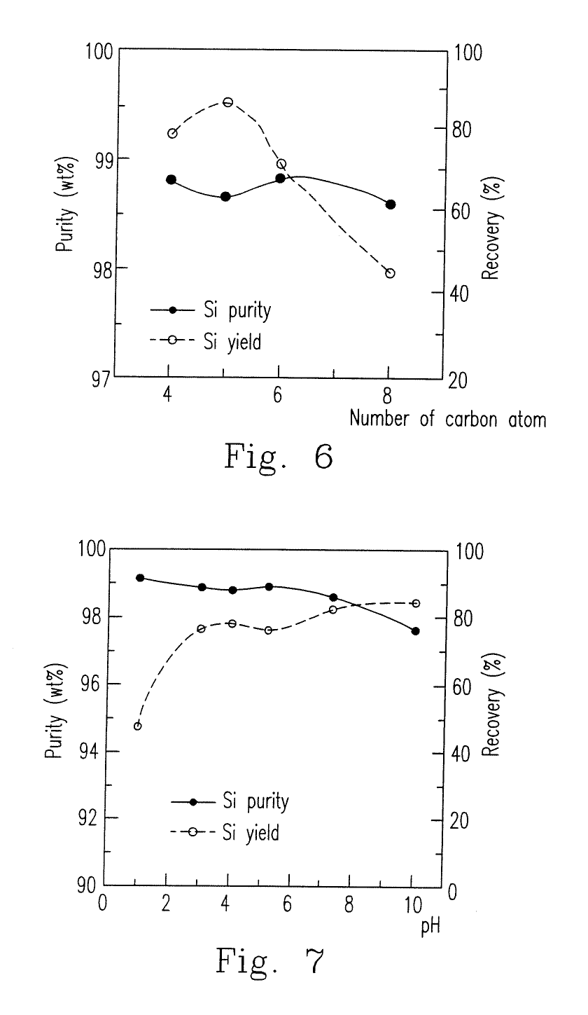

Next, the effect of alcohol with long carbon chain, including n-butanol, n-pentanol, n-heptanol and n-octanol, on separation of silicon is studied. Please refer to FIG. 6, which illustrates a diagram showing the effect of the carbon number of alcohol in the second oil phase on purity and recovery of silicon in the second-staged particle phase-transfer method. In FIG. 6, the experimental parameters are controlled at the initial purity of silicon of 96.6 wt %, solid concentration of 2 wt %, oil/water volume ratio of 1/3 and pH value of water phase of 4. Purity of the separated silicon scatters between 98.6 wt % and 98.8 wt % when the number of carbon atom of alcohols is varied; however, recovery of silicon decreases from 78.5% to 44.0% with the increased carbon number of alcohols.

Experiment 6: Effect of pH Value of the Second Water Phase in the Second Stage

The pH value of water phase in the second stage is controlled between 1 and 10, and other experimental parameters are controlled at the initial purity of silicon of 96.6 wt %, solid concentration of 2 wt %, oil/water ratio of 1/3 and n-butanol (with density of 0.82 g/cm³) to be the second oil. Please refer to FIG. 7, which illustrates a diagram showing the effect of pH value of the second water phase on purity and recovery of silicon in the second-staged particle phase-transfer method. In FIG. 7, purity of the separated silicon increases from 97.6 wt % to 99.1 wt % when pH value of the second water phase decreases from 10 to 1. The separation effect has been significantly risen and purity of the recovered silicon reaches 98.8 wt % when pH value of water phase is less than 6. In addition, recovery of silicon decreases from 84.4% to 47.3% with pH value of water phase decreased from 10 to 1.

Experiment 7: Effect of the Solid Concentration in the Second Stage

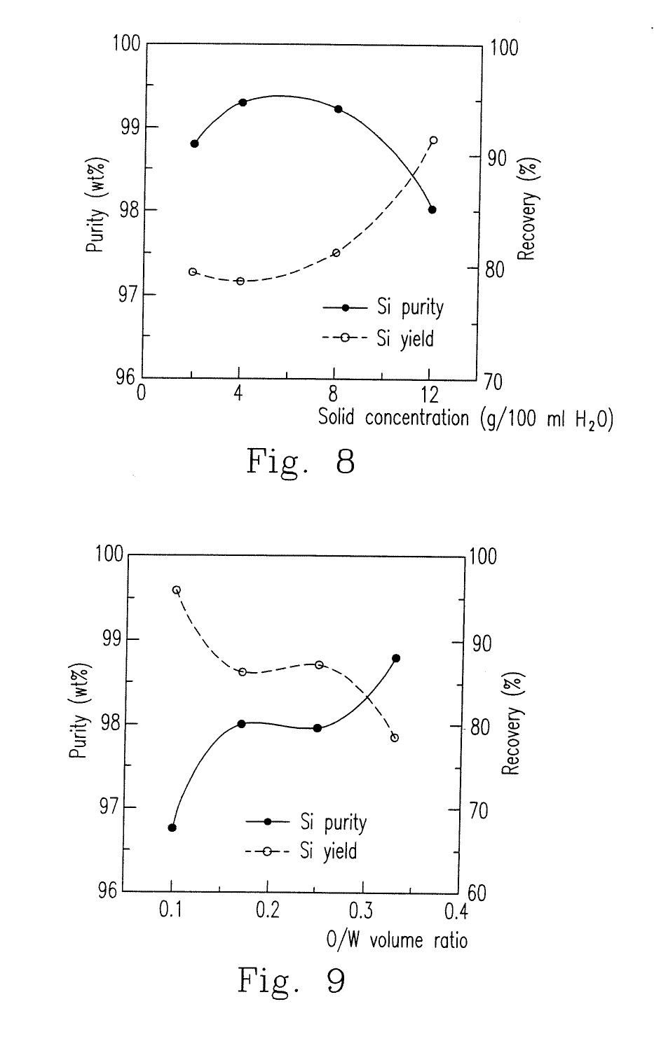

Although the separation can be effectively achieved using 2 wt % slurry in the second-staged treatment, recovery rate of silicon might be too low. Therefore, solid concentration is adjusted to increase recovery of silicon. Please refer to FIG. 8, which illustrates a diagram showing the effect of the solid concentration on purity and recovery of silicon in the second-staged particle phase-transfer method. In FIG. 8, the experimental parameters are controlled at the initial purity of silicon of 96.6 wt %, oil/water volume ratio of 1/3, n-butanol (with density of 0.82 g/cm³) being the second oil and pH value of water phase of 4. Purity of the recovered silicon increases from 98.8 wt % to 99.3 wt % and then decreases to 98 wt % and recovery of silicon increases from 78.5% to 89.7% when solid concentration increase from 2 wt % to 12 wt %.

Experiment 8: Effect of oil/water volume ratio in the second stage

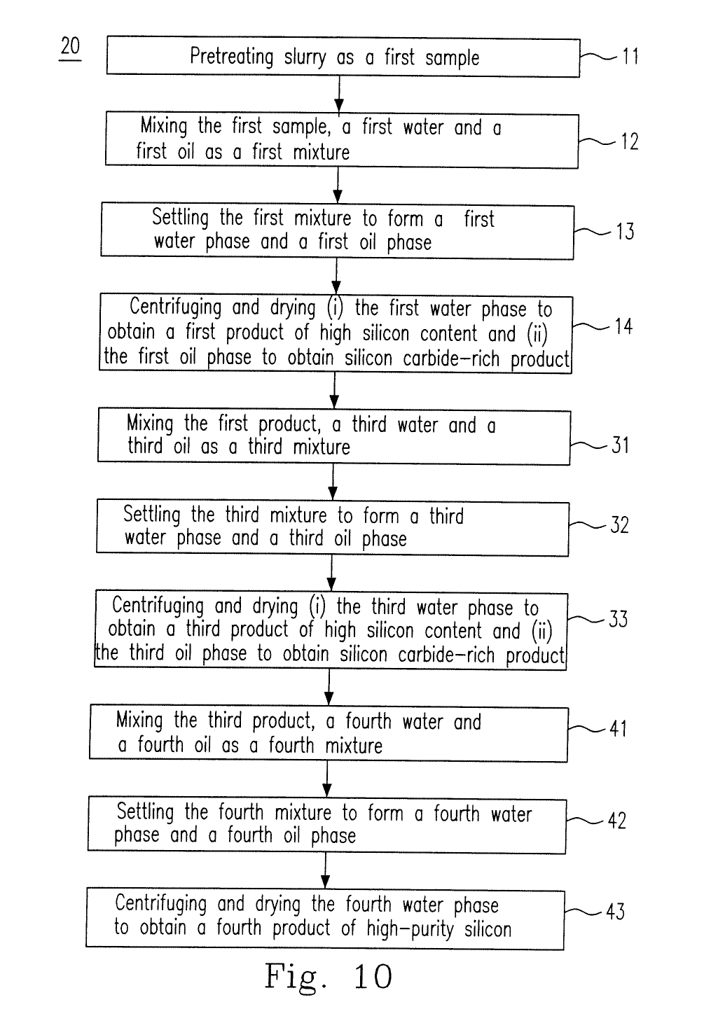

In addition to solid concentration being the important parameter, oil/water volume ratio also is another important parameter in designing a practical mixer-settler. Please refer to FIG. 9, which illustrates a diagram showing the effect of oil/water volume ratio on purity and recovery of silicon in the second-staged particle phase-transfer method. In FIG. 9, the experimental parameters are controlled at the initial purity of silicon of 96.6 wt %, n-butanol (with density of 0.82 g/cm³) being the second oil, pH value of water phase of 4 and solid concentration of 2 wt %. Purity of silicon decreases from 98.8 wt % to 96.7 wt %, but recovery of silicon increases from 78.5% to 95.9% when oil/water ratio decreases from 1/3 to 1/10.

### Embodiment 2

In another two-staged particle phase-transfer method, the experimental parameters in the first stage is controlled at pH value of water phase of 6.1, solid concentration of 4 wt %, oil/water volume ratio of 1/3 and the first oil density of 1.1 g/cm³. Other steps follows the steps in Embodiment 1. Purity of the recovered silicon increases from 73.1 wt % to 96.6 wt % with recovery of silicon of 80.3%. In addition, SiC powder in the first oil phase is also recovered, and purity of the recovered SiC is 63.3 wt % with recovery of SiC of 92.3%. Further, the experimental parameters in the second stage is controlled at pH value of water phase of 4, solid concentration of 8 wt % and oil/water volume ratio of 1/3. Purity of silicon increases from 96.6 wt % to 99.1 wt % with recovery of silicon of 80.6%. Therefore, purity of silicon of 73.1 wt % is purified up to 99.1 wt % with an overall recovery of silicon of 64.7% in the two-staged treatment. In addition, purity of the recovered SiC is 63.3 wt % with a recovery of SiC more than 90%.

### Embodiment 3

Please refer to FIG. 10, which illustrates a flowchart in accordance with a third preferred embodiment of the present invention. Steps 11 to 14 of the method 20 (i.e. three stages) shown in FIG. 10 are identical with steps 11 to 14 and 24 of the method 10 (i.e. two stages) shown in FIG. 1, and thus the illustration of steps 11 to 14 of the method 20 are omitted. Steps 11 to 14 of the method 20 in FIG. 10 are referred to the first stage. In the second stage, the first product is sequentially mixed with the third water and the third oil to form a third mixture (step 31). The experimental process of Embodiment 3 is illustrated as follows.

In the first-staged treatment, silicon and SiC respectively account for 20.96 wt % and 79.03 wt % of the overall first sample. Although weight percentage of silicon is lower than that of SiC, density of oil phase must be higher than that of the water phase in the first stage so as to withdraw the relatively large particle size SiC. Other experimental parameters are controlled at pH value of water phase of 6, the first oil (with density of 1.1 g/cm³) combined from CHBr₃ and n-butanol, solid concentration of 2 wt % and oil/water volume ratio of 1/3. The first mixture is mixed for 5 minutes and then settled for 10 minutes. Purity of silicon in the separated first product is ranged between 80.0 wt % and 84.0 wt % with recovery of 83.0%. In addition, SiC in the first oil phase is also recovered, and purity of the obtained SiC is 97 wt % with recovery of SiC more than 90%.

Next, the first product is sequentially mixed with the third water and the third oil to form the third mixture, wherein the third oil (with density of 1.1 g/cm³) also is composed of CHBr₃ and n-butanol. Other experimental parameters are controlled at pH value of water phase of 6, solid concentration of 2 wt % and oil/water ratio of 1/3. With 5-minute mixing and 10-minute settling, purity of silicon is 96.6 wt % with recovery of silicon of 90.2%. In addition, SiC in the third oil phase is also recovered, and purity of the obtained SiC is more than 80 wt % with recovery of SiC more than 70%.

Since relatively large particles of SiC are removed in the first and the second stages, pure solvent (i.e. n-butanol) is adopted as the fourth oil phase in the third stage. The fourth product is obtained from the fourth water phase after settling and layer separation of the fourth mixture, wherein purity of silicon is up to 98.3 wt % with recovery of silicon of 89.0%. Therefore, purity of silicon of 20.96 wt % in the slurry can be purified to more than 98.3 wt % in the three-staged treatment of Embodiment 3, and an overall recovery of silicon is up to 66.6%. In addition, purity of the recovered first SiC is 97 wt % with an overall recovery of SiC more than 90%. Accordingly, the first silicon carbide powder can be directly recycled to be used in wire-saw system.

Therefore, because of the difference of surface hydrophilicity/hydrophobicity on silicon and silicon carbide and specific gravity differences between the water phase and the oil phase, silicon and silicon carbide respectively can be efficiently recovered from the slurry in the wire-saw process by particle phase-transfer method. Further, regardless of weight percentage of silicon in the slurry, both of silicon and silicon carbide with high purities can be efficiently recovered by adjusting the experimental parameters, and the overall recovery of silicon is relatively high.

Comparing with other centrifugation methods, a fewer amount of organic solvent is used and the overall processing time is substantially decreased in the particle phase-transfer method. Further, the drawback that the small particle size (less than 1 μm) SiC cannot be removed in the prior art (i.e. centrifugation) is able to be overcome by the method disclosed in the present invention

Among a plenty of organic solvents, n-butanol being the oil shows the best separation result. Further, the relatively large particles of SiC can be efficiently removed by the relatively high-density first oil phase which is composed of CHBr₃ and n-butanol, as compared with centrifugation. In addition, the increased solid concentration would result in a decrease of silicon purity. When the oil/water ratio is increased, the Si purity is increased, but with a decrease in recovery. Therefore, the adequate oil/water ratio is ranged between 1/4 and 1/3.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for obtaining at least one of a silicon and a silicon carbide, the method comprising steps of:
(a) providing a first sample;
(b) sequentially mixing the first sample with a first water and a first oil to form a first mixture;
(c) settling the first mixture to form a first water phase having a first water phase specific gravity and a first oil phase having a first oil phase specific gravity, wherein the specific gravity of the first water phase is lower than the specific gravity of the first oil phase; and
(d) centrifuging and drying the first water phase to obtain a first product with a high silicon content and drying the first oil phase to obtain the silicon carbide-rich product.

2. The method according to claim 1, wherein the first sample is a kerf loss slurry comprising the silicon, the silicon carbide, an ethylene glycol and a metal fragment, and the step (a) further comprises steps of:
(a1) washing the slurry with an acetone to remove the ethylene glycol therefrom;
(a2) mixing the slurry with a nitric acid to dissolve the metal fragment therefrom and to obtain a preliminarily purified slurry;
(a3) centrifuging and drying the preliminarily purified slurry to obtain a powder mixture, which includes the silicon and the silicon carbide, being the first sample.

3. The method according to claim 1, wherein the first oil comprising an alcohol having a carbon number≧4 and a tribromomethane or comprising an alkane having a carbon number≧4 and the tribromomethane, and the step (b) further comprises a step (b1) of adding a surfactant into the first sample after the first sample and the first water are mixed.

4. The method according to claim 3, wherein the surfactant is a sodium hexametaphosphate, and the step (b1) further comprises a step (b11) of adjusting a pH value of the first sample with one of an acid or a base.

5. The method according to claim 4, wherein the pH value is ranged between 3.0 and 10.3, the acid is a hydrochloride, and the base is a sodium hydroxide.

6. The method according to claim 1, wherein the first mixture has a first ratio of the first oil to the first water ranged between 1/10 and 1/3, and the first mixture has a solid concentration ranged between 2 wt % and 16 wt %.

7. The method according to claim 1, wherein the silicon has a first weight percentage and the silicon carbide has a second weight percentage.

8. The method according to claim 7, wherein the first percentage is equal to or greater than the second percentage, and the method further comprises steps of:
(e) sequentially mixing the first product with a second water and a second oil to form a second mixture;
(f) settling the second mixture to form a second water phase having a second water phase specific gravity and a second oil phase having a second oil phase specific gravity, wherein the specific gravity of the second water phase is higher than the specific gravity of the second oil phase; and
(g) centrifuging and drying the second water phase to obtain a second product of high-purity silicon.

9. The method according to claim 8, wherein the second oil is a solvent being one selected from a group consisting of an organic compound, such as an aromatic, an alkane, an alcohol, an ether and a diesel.

10. The method according to claim 9, wherein the aromatic is a xylene, the alkane has a carbon number≧4 and comprises an n-heptane and an isooctane, the alcohol has a carbon number C≧4 and comprises an n-butanol, an n-pentanol, an n-hexane and an n-octanol, and the ether is an isopropyl ether.

11. The method according to claim 8, wherein the second mixture has a second ratio of the second oil over the second water ranged between 1/10 and 1/3, and the second mixture has a solid concentration ranged between 2 weight percentage (wt %) and 12 wt %.

12. The method according to claim 8, wherein the step (e) further comprises a step (e1) of adding a surfactant into the first product after the first product and the second water are mixed.

13. The method according to claim 12, wherein the step (e1) further comprises a step (e11) of adjusting a pH value of the first product with one of an acid or a base, the pH value is ranged between 1.0 and 10.0, the acid is a hydrochloride, and the base is a sodium hydroxide.

14. The method according to claim 7, wherein the first percentage is lower than the second percentage, and the method further comprises steps of:
(e) sequentially mixing the first product with a third water and a third oil to form a third mixture;
(f) settling the third mixture to form a third water phase having a third water phase specific gravity and a third oil phase having a third oil phase specific gravity, wherein the specific gravity of the third water phase is lower than the specific gravity of the third oil phase; and
(g) centrifuging and drying the third water phase to obtain a third product of high silicon content and drying the third oil phase to obtain the silicon carbide-rich powder.

15. The method according to claim 14 further comprising steps of:
(h) sequentially mixing the third product with a fourth water and a fourth oil to form a fourth mixture;
(i) settling the fourth mixture to form a fourth water phase having a fourth water phase specific gravity and a fourth oil phase having a fourth oil phase specific gravity, wherein the specific gravity of the fourth water phase is higher than the specific gravity of the fourth oil phase; and
(j) centrifuging and drying the fourth water phase to obtain a fourth product of high-purity silicon.

16. A method for obtaining at least one of a silicon and a silicon carbide, the method comprising steps of:
(a) providing a first sample;
(b) mixing the first sample, a first water and a first oil to obtain a first mixture;
(c) settling the first mixture into a water layer having a first density and an oil layer having a second density, wherein the first density is lower than the second density; and
(d) centrifuging and drying the water layer to obtain a product of high silicon content and the oil layer to obtain the silicon carbide-rich product.

17. The method according to claim 16, wherein the step (b) is performed by sequentially mixing the first sample with the first water and the first oil.

18. A method for recovering at least one of a silicon and a silicon carbide from a slurry, the method comprising steps of:
(a) administrating the slurry as a first sample;
(b) mixing the first sample with a hydrophilic solvent and a hydrophobic solvent to obtain a first mixture;
(c) settling the first mixture to form a layer of hydrophilic solvent having a first specific gravity and a layer of hydrophobic solvent having a second specific gravity, wherein the first specific gravity is lower than the second specific gravity; and
(d) centrifuging and drying the layer of hydrophilic solvent to obtain a product of high silicon content and the layer of hydrophobic solvent to obtain the silicon carbide-rich product.

19. The method according to claim 18, wherein the step (b) is performed by sequentially mixing the first sample with the hydrophilic solvent and the hydrophobic solvent.
